(19) United States
(12) Patent Application Publication
(10) Pub. No.: US 2006/0185949 A1
(43) Pub. Date: Aug. 24, 2006

(54) Center seeking suspension system

(75) Inventor: David K. Platner, Shelby, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/064,324

(22) Filed: Feb. 23, 2005

(51) Int. Cl. F16F 9/00

(52) U.S. Cl. 188/313

(57) ABSTRACT

A suspension system includes a fluid strut that operates with a compressible fluid such as silicon oil. The fluid strut includes an outer cylinder, an inner cylinder received within the outer cylinder, and a plate positioned between an inner surface of the outer cylinder and an outer surface of the inner cylinder. The plate separates a fluid chamber within the outer cylinder into a main chamber and an auxiliary chamber. The inner cylinder defines an inner chamber that is in fluid communication with both the auxiliary and main chambers. A two-way valve directs fluid flow between the main and inner chambers. A three-way valve directs flow between the auxiliary and inner chambers. A controller operates each valve to control flow of the compressible fluid within the fluid strut to obtain an infinitely variable self-centering suspension system.

### BACKGROUND OF THE INVENTION

The present invention relates to a suspension system, and more particularly to an active suspension system that utilizes a compressible fluid.

Conventional suspension systems isolate a vehicle frame or chassis from impacts and vibrations resulting from vehicle wheels traversing uneven terrain. Vehicle ride characteristics have complex dynamics. Excess vibration can have detrimental consequences on suspension components, often resulting in premature wear or failure.

Current passive suspension systems employ springs, struts, rubber elements, torsion bars, or the like to maintain a centered suspension. Perturbations from a normal condition initiates a harmonic motion that would continue indefinitely but for the addition of damping mechanisms such as shocks, or other hysteresis or coulomb damping devices. Current suspension technologies are defined in frequency domains with natural frequencies and damping coefficients to define suspension characteristics. Such passive suspension systems offer a compromise between spring and dampening coefficients of fixed rates.

Current active suspension systems provide powered components that isolate the vehicle chassis from vibrations induced by uneven terrain. In active vehicle suspension systems, actuators are provided to actively apply forces, which counteract and balance forces applied to the chassis of the motor vehicle. Such active systems utilize relatively complicated control schemes to determine an amount of force that the actuators should apply to the vehicle chassis to provide a smoother ride. As examples, known schemes include some schemes based on balancing the forces acting on the vehicle chassis, and some schemes based on supporting the vehicle chassis at a selected ride height. Active suspension systems require relatively large power inputs so that the actuator will be quick enough to compensate for impacts and vibrations that occur at desired traveling velocities over rough terrain. The power requirements for such fully active suspension systems are generally prohibitively demanding.

Another type of active suspension system utilizes an incompressible fluid. An example of such a system is disclosed in U.S. application Ser. No. 10,785,880, filed Feb. 24, 2004 and which is assigned to the assignee of the subject invention. This type of center seeking suspension uses a fluid strut, an accumulator that is in fluid communication with the fluid strut via an accumulator valve, and a reservoir that is in fluid communication with the fluid strut via a reservoir valve. A fluid pump pressurizes the accumulator with an incompressible fluid stored in the reservoir. A controller operates each valve and the fluid pump to control flow of the incompressible fluid within the strut. The controller operates each valve and the fluid pump to exploit the incompressible properties of the incompressible fluid to obtain an infinitely variable suspension system.

One of the advantages with this type of suspension system is that the suspension system responds rapidly and uses relatively minimal power inputs and damping elements. However, one disadvantage is that a significant number of fluid connections are required to interconnect various valves, the fluid strut, and the reservoir. This increases assembly time and overall system cost. Further, these fluid connections, the accumulator, and the reservoir take up valuable packaging space underneath the vehicle chassis.

Accordingly, it is desirable to provide an active center seeking suspension system that can respond rapidly using minimal power inputs and damping elements, and which is more compact and easily installed on a vehicle.

### SUMMARY OF THE INVENTION

The suspension system according to the present invention includes a fluid strut between a sprung load such as a vehicle chassis and an unsprung load such as a vehicle axle assembly. The fluid strut includes an outer cylinder defining a first fluid chamber and an inner cylinder defining a second fluid chamber, wherein the inner cylinder is at least partially received within the outer cylinder. A rod is mounted for movement relative to the inner and outer cylinders and has one rod end extending into the second fluid chamber. A compressible fluid, such as silicon oil for example, is contained within the first and second fluid chambers. A valve and controller cooperate to control flow of the compressible fluid between the first and second fluid chambers to provide a desired suspension rate and ride height.

In one example, a plate is received within the outer cylinder and surrounds the inner cylinder. The plate separates the first fluid chamber into a main chamber and an auxiliary chamber. A first valve directs fluid flow between the main chamber and the second fluid chamber. A second valve directs flow between the auxiliary chamber and the second fluid chamber. Preferably, the first valve is a two-way valve and the second valve is a three-way valve. A transfer pump is positioned within the inner cylinder between the second valve and the end of the rod. The controller controls the two-way valve to adjust suspension rate by controlling a total volume of the compressible fluid. The controller controls the three-way valve and transfer pump to increase ride height as needed, and/or to maintain ride height as the compressible fluid exits the fluid strut over time.

The present invention therefore provides an active center seeking suspension system that responds rapidly while utilizing minimal power inputs and damping elements, and which is compact and easy to install.

These and other features of the present invention can be best understood from the following specification and drawings, the following of which is a brief description.

### BRIEF DESCRIPTION OF THE DRAWINGS

FIG. 1 is a schematic view of one example of an active suspension system incorporating the subject invention.

FIG. 2 is a schematic view of another example of an active suspension system incorporating the subject invention.

FIG. 3 is a graphical representation of an active suspension system designed according to the subject invention.

### DETAILED DESCRIPTION OF THE PREFERRED EMBODIMENT

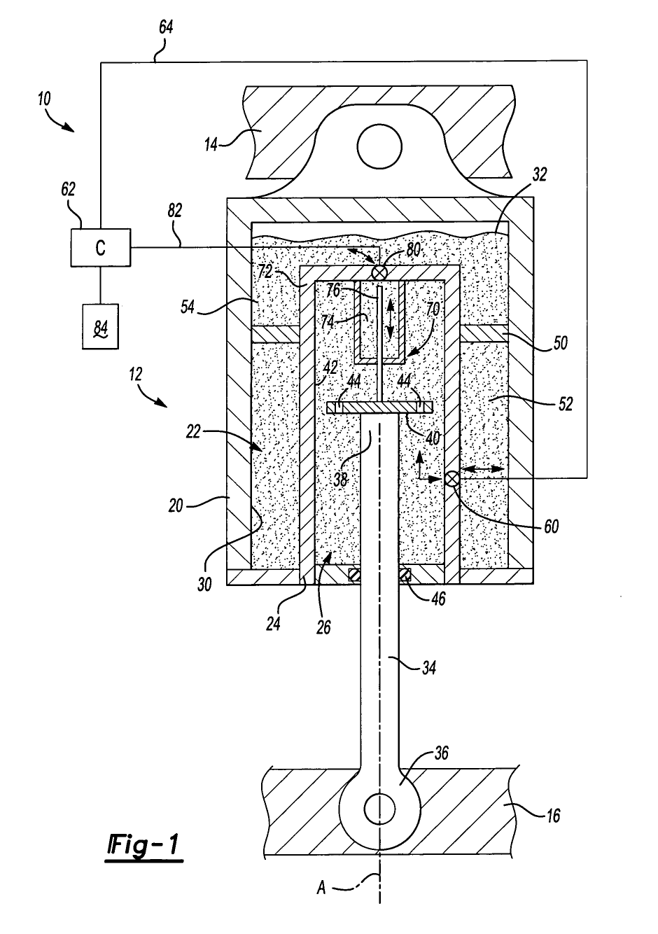

FIG. 1 illustrates a general schematic view of a suspension system 10 for a vehicle. The suspension system 10 generally includes a fluid strut 12 between a sprung load 14 such as a vehicle chassis and an unsprung load 16 such as a vehicle axle assembly. It should be understood that although only a single suspension system 10 is disclosed in the illustrated embodiment such a suspension system will be utilized for each vehicle wheel or the like. Preferably, the suspension system 10 is an active suspension system that isolates vehicle chassis from vibrations induced at each wheel by uneven terrain by actively applying forces, which counteract and balance forces applied to the chassis of the vehicle.

The fluid strut 12 has an outer cylinder 20 defining a first fluid chamber 22 and an inner cylinder 24 defining a second fluid chamber 26. The inner cylinder 24 is at least partially received within said first fluid chamber 22, which extends at least in part, between an outer wall 28 of the inner cylinder 24 and an inner wall 30 of the outer cylinder 20.

The first 22 and second 26 fluid chambers are at least partially filled with a compressible fluid 32. Compressible fluids have densities that can vary in response to changes in pressures exerted on the compressible fluid. One example of a compressible fluid that could be used in the fluid strut 12 is silicon oil, however, other compressible fluids could also be used. The specific properties of compressible fluids are generally well-known and will not be discussed in further detail.

A rod 34 has a first rod end 36 and a second rod end 38 that extends into the second fluid chamber 26. The rod 34 moves back-and-forth within the inner cylinder 24 along an axis A as the vehicle and suspension system 10 travels over a ground surface. Seals 46 are installed between the rod 34 and inner cylinder 24 to seal the second fluid chamber 26. The rod 34 and the compressible fluid 32 within the first 22 and second 26 fluid chambers cooperate to provide a desired suspension rate and ride height. This will be discussed in greater detail below.

A damper plate 40 is mounted to the rod 34 adjacent to the second rod end 38. The damper plate 40 has a greater diameter than the rod 34 but does not touch an inner surface 42 of the inner cylinder 24. The damper plate 40 moves with the rod 34 along the axis A. The damper plate 40 may include openings 44 that extend through the damper plate 40 such that the compressible fluid 32 can flow through the damper plate 40. The damper plate 40 provides additional damping as needed, however, the suspension system 10 may not require a damper plate 40.

In the example shown, the outer cylinder 20 is mounted to the sprung load 14 and the first rod end 36 is mounted to the unsprung load 16, however, other mounting configurations could also be used. A rigid plate 50 separates the first fluid chamber 22 into a main chamber 52 and an auxiliary chamber 54. The auxiliary chamber 54 is a low pressure volume and the main chamber 52 is a high pressure volume. The second fluid chamber 26 is also a high pressure volume that is in fluid communication with main chamber 52 through a first valve 60. The rigid plate 50 abuts against the outer wall 28 of the inner cylinder 24 and the inner wall 30 of the outer cylinder 20. The rigid plate 50 can be fixedly mounted to either or both of the inner 24 and outer 20 cylinders. Respective positions of the outer cylinder 20, the inner cylinder 24, and the rigid plate 50 remain fixed relative to each other and remain fixed relative to the sprung load 14.

The first valve 60 controls fluid flow between the main chamber 52 and the second fluid chamber 26 to adjust an instantaneous rate of the suspension system 10. Preferably, the first valve 60 is an ON/OFF, i.e., open/closed, two-way valve that provides extremely rapid reaction times. This type of valve is also often referred to as a bang-bang valve. The first valve 60 is normally open or ON during vehicle operation. In this position, the compressible fluid 32 flows back and forth between the main chamber 52 and second fluid chamber 26 to increase compressible fluid volume. To increase stiffness, the first valve 60 is closed or turned OFF.

A controller 62 determines when the first valve 60 should be closed and generates a control signal 64 that is communicated to the first valve 60. Suspension rate is adjusted by effectively controlling a total fluid volume of the compressible fluid 32. When the first valve 60 is open the fluid strut 12 has a first predefined operational fluid volume. When the first valve 60 is closed, the fluid strut 12 has a second predefined operational fluid volume that is less than the first predefined operational fluid volume. In other words, when the first valve 60 is open, the first predefined operational fluid volume is defined by at least an amount of compressible fluid 32 within the second fluid chamber 26 and within the main chamber 52. When the first valve 60 is closed the second predefined operation fluid volume does not include compressible fluid 32 within the main chamber 52, thus the overall fluid volume is reduced when the first valve 60 is closed.

The controller 62 determines when the first valve 60 should be opened or closed based on a desired suspension rate and in response to suspension inputs exerted on the rod 34. Thus, the controller 62 automatically adjusts suspension rate as needed by adjusting the stiffness of the fluid strut 12 by opening and closing the first valve 60.

The fluid strut 12 also includes a transfer pump 70 that is mounted within the inner cylinder 24. The transfer pump 70 is positioned between a bottom wall 72 of the inner cylinder and the second rod 38. The transfer pump 70 includes a pump body 74 that is fixed to the bottom wall 72 of the inner cylinder 24 and a pump needle 76 that is mounted for movement with the rod 34 along the axis A. The pump needle 76 moves back and forth within the pump body 74 and is coupled to the second rod end 38.

The transfer pump 70 pumps the compressible fluid 32 within the second fluid chamber 26 and cooperates with a second valve 80. The second valve 80 controls fluid flow between the auxiliary chamber 54 and the second fluid chamber 26. The transfer pump 70 and second valve 80 utilize road perturbations to pump fluid into the high pressure volume of the main chamber 52 via the second fluid chamber 26 and first valve 60. This provides adjustment to achieve desired ride height variations while the vehicle is operating.

The second valve 80 is preferably a three-way valve that allows for adjustment of ride height by transferring compressible fluid 32 into or out of the auxiliary chamber 54. The second valve 80 responds to a control signal 82 generated by the controller 62. The second valve 80 is normally closed during vehicle operation. The second valve 80 is selectively opened in response to receipt of the control signal 82 to adjust ride height as needed. The second valve 80 allows either two-way flow of the compressible fluid 32 back-and-forth between the auxiliary chamber 54 and the second fluid chamber 26 during vehicle operation or one-way flow from the auxiliary chamber 54 to the second fluid chamber 26 or vice-versa to adjust ride height when the vehicle is stationary.

Thus, the controller 62 operates the first 60 and second 80 valves to control flow of the compressible fluid 32 as needed to adjust right height and suspension rate. The controller 62 is also in communication with at least one sensor 84 that monitors a position of the pump needle 76 and/or rod 34 relative to at least one of the inner 24 and outer 20 cylinders. The sensor 84, which is shown schematically, can be incorporated within the fluid strut 12 or can be externally positioned relative to the fluid strut 12. The suspension system 10 may also include other sensors, such as pressure sensors, as needed.

The controller 62 operates the first 60 and second 80 valves to exploit the compressible properties of the compressible fluid 32 to obtain an infinitely variable suspension system. In response to operating requirements, the controller 62 selects a stiffness range to provide sufficient centering forces to return the suspension system 10 to a desired center without overshoot. The controller 62 preferably minimizes any bouncing and therefore minimizes the requirement for energy wasting damping. It should be understood that various well-known control algorithms would benefit from the present invention.

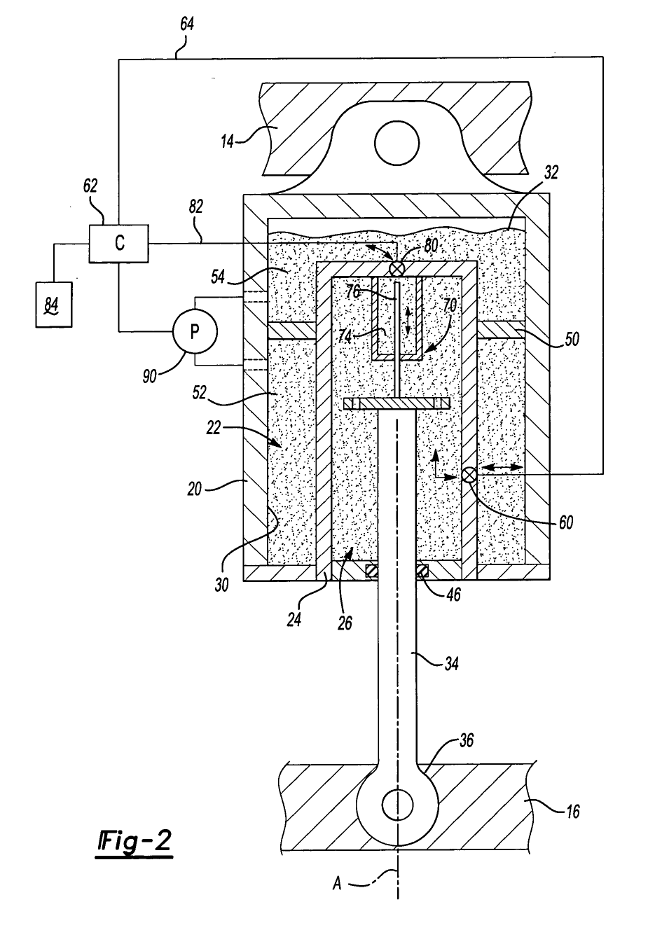

FIG. 2 shows an optional configuration, similar to that shown in FIG. 1, but which includes an auxiliary powered pump 90. The auxiliary powered pump 90 can be used to adjust ride height when the vehicle is stationary and/or unpowered. Thus, the suspension system 10 can provide a leveling function to adjust ride height when parked. The auxiliary powered pump 90 transfers compressible fluid 32 from the auxiliary chamber 54 directly to the main chamber 52 as needed to increase or decrease ride height.

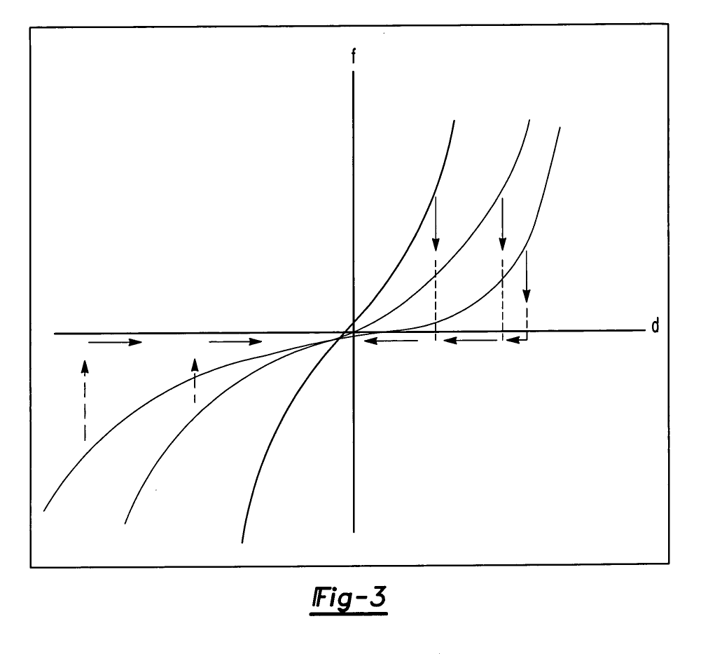

Referring to FIG. 3, the suspension system 10 provides an infinitely variable system spring rate. The spring rate relates force (f) applied to the suspension system 10 to a distance (d) which the suspension system 10 will travel in relation to perturbations. By opening or closing the first 60 and second 80 valves, the suspension rate may immediately dissipate toward an origin as illustrated by the phantom lines. That is, the suspension system 10 operates at a predefined system spring rate unless the force (f) is “dumped” by the controller 62 via at least one of the first 60 and second 80 valves. Strut height, balance and timing of valve operation is performed by the controller 62 and the logic contained therein. Further, both the first 60 and second 80 valves have a high responsiveness combined with a relatively low actuation force. Thus, the suspension system 10 can respond rapidly using minimal power inputs and damping elements when compared to prior designs.

Additionally, the suspension system 10 can automatically adjust ride height in response to leakage of compressible fluid 32 from the seals 46. Over time, the seals 46 are subjected to wear, which decreases a sealing force of the seals 46 against the rod 34. Some compressible fluid 32 may leak out of the fluid strut 12 through the seals 46 in such a situation. The controller 62 can automatically add compressible fluid 32 from the auxiliary chamber 54 to the main chamber 52, via the second fluid chamber 26, to maintain a generally constant desired ride height over time.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A fluid strut for a vehicle suspension system comprising:
an outer cylinder including a first fluid chamber for receiving a compressible fluid;
an inner cylinder including a second fluid chamber in fluid communication with the first fluid chamber;
a rod movable within said inner cylinder wherein one of said outer cylinder and said rod is attachable to a sprung mass and the other of said outer cylinder and said rod is attachable to an unsprung mass;
at least one valve directing fluid flow between said first and said second fluid chambers as said rod moves within said second fluid chamber; and
a controller in communication with said at least one valve to control fluid communication of the compressible fluid between said first and said second fluid chambers to provide a desired suspension rate during vehicle operation.

2. The fluid strut according to claim 1 wherein said at least one valve includes a two-way valve that is either open or closed.

3. The fluid strut according to claim 2 wherein said two-way valve is normally open during vehicle operation and wherein said two-way valve is closed in response to said controller generating a control signal to increase suspension stiffness

4. The fluid strut according to claim 3 wherein the fluid strut has a first predefined compressible fluid volume when said two-way valve is open and has a second predefined compressible fluid volume when said two-way valve is closed, said second predefined compressible fluid volume being less than said first predefined compressible fluid volume.

5. The fluid strut according to claim 2 including a plate abutting against an inner surface of said outer cylinder and abutting against an outer surface of said inner cylinder, said plate separating said first fluid chamber into a main chamber and an auxiliary chamber and wherein said two-way valve directs flow between said main chamber and said second fluid chamber and wherein said auxiliary chamber is in fluid communication with said second fluid chamber.

6. The fluid strut according to claim 5 including a three-way valve supported by said inner cylinder that directs fluid flow between said auxiliary chamber and said second fluid chamber.

7. The fluid strut according to claim 6 including a transfer pump enclosed within said inner cylinder and positioned between said three-way valve and an end of said rod.

8. The fluid strut according to claim 7 wherein said transfer pump includes a pump body fixed to said inner cylinder and a needle coupled to said end of said rod such that said needle is movable within said pump body.

9. The fluid strut according to claim 8 wherein said three-way valve is normally closed and is selectively moved to an open position to adjust ride height as needed by allowing either two-way flow of the compressible fluid back and forth between said auxiliary chamber and said second fluid chamber or one-way flow from said auxiliary chamber to said second fluid chamber.

10. The fluid strut according to claim 5 including an auxiliary powered pump in fluid communication with said auxiliary chamber and said main chamber, said auxiliary powered pump being selectively actuated to adjust ride height when a vehicle is stationary.

11. The fluid strut according to claim 1 including a damper plate attached for movement with said rod within said second fluid chamber, said damper plate having a greater diameter than said rod, and wherein said damper plate is spaced apart from an inner surface of said inner cylinder.

12. A fluid strut for a vehicle suspension system comprising:
an outer cylinder adapted for attachment to a vehicle chassis and including a first fluid chamber for receiving a compressible fluid;
an inner cylinder at least partially received within said first fluid chamber, said inner cylinder including a second fluid chamber that is in fluid communication with the first fluid chamber;
a plate abutting against an inner surface of said outer cylinder and abutting against an outer surface of said inner cylinder, said plate separating said first fluid chamber into a main chamber and an auxiliary chamber;
a rod adapted for attachment to a vehicle wheel, said rod extending into said second fluid chamber;
a first valve directing flow between said main chamber and said second fluid chamber;
a second valve directing flow between said auxiliary chamber and said second fluid chamber;
a transfer pump positioned within said inner cylinder between said second valve and an end of said rod; and
a controller in communication with said first and said second valves to control fluid communication of the compressible fluid between said main chamber, said second fluid chamber, and said auxiliary chamber to provide a desired suspension rate during vehicle operation and to vary ride height as needed.

13. The fluid strut according to claim 12 wherein said first valve comprises a two-way valve and said second valve comprises a three-way valve.

14. The fluid strut according to claim 12 including a damper plate mounted adjacent said end of said rod, said damper plate including a plurality of openings for directing the compressible fluid through the damper plate.

15. The fluid strut according to claim 12 wherein said transfer pump includes a pump body fixed to an inner wall of said inner cylinder and a needle coupled to said end of said rod such that said needle is movable within said pump body.

16. The fluid strut according to claim 12 wherein the compressible fluid is silicon oil.

17. A method of controlling an active suspension system comprising the steps of:
(a) mounting an outer cylinder to a vehicle chassis;
(b) mounting an inner cylinder within a first fluid chamber defined by the outer cylinder;
(c) mounting a rod to a vehicle wheel such that the rod extends into a second fluid chamber defined by the inner cylinder;
(d) holding the inner and outer cylinders fixed relative to each other;
(e) moving the rod within the second fluid chamber in response to a suspension input; and
(f) controlling flow of a compressible fluid between the first and second fluid chambers to adjust suspension rate and ride height as needed.

18. The method according to claim 17 including separating the first fluid chamber into a main chamber and an auxiliary chamber, controlling flow of the compressible fluid between the main chamber and the second fluid chamber with a two-way valve, and controlling fluid flow between the auxiliary chamber and the second fluid chamber with a three-way valve.

19. The method according to claim 18 including leaving the two-way valve normally open during normal vehicle operation and closing the two-way valve in response to receipt of a control signal for increasing suspension stiffness.

20. The method according to claim 18 including leaving the three-way valve normally closed and opening the three-way valve to allow fluid flow from the auxiliary chamber to the second fluid chamber to maintain a generally constant desired ride height in response to compressible fluid leaking out of a strut seal over time.
